(19) United States
(12) Patent Application Publication
(10) Pub. No.: US 2013/0060491 A1
(43) Pub. Date: Mar. 7, 2013

(54) Thermal Mass Flow Meter

(71) Applicant: Anthony Valenzano, Archbald, PA (US)

(72) Inventor: Anthony Valenzano, Archbald, PA (US)

(73) Assignee: TECHOX INDUSTRIES, INC., Wilkes Barre, PA (US)

(21) Appl. No.: 13/604,975

(22) Filed: Sep. 6, 2012

Related U.S. Application Data
(60) Provisional application No. 61/531,331, filed on Sep. 6, 2011.
(60) Provisional application No. 61/531,393, filed on Sep. 6, 2011.

(51) Int. Cl. G01F 1/68; G06F 19/00

(52) U.S. Cl. 702/45

(57) ABSTRACT

A thermal mass flow meter is disclosed wherein a sensor board with at least one heating element and at least two temperature sensors locates inside a housing where the gas or fluid is flowing. The heating element is turned on and off and a microprocessor is programmed to calculate a flow rate based on a logarithmic function of temperature differences between a pair of sensor before the heating cycle and after the heating cycle.

### PRIORITY

This application claims priority of the U.S. provisional application Nos. 61/531,331 and 61/531,393 both of which were filed on Sep. 6, 2011 and the contents of which are fully incorporated herein by reference.

### FIELD OF THE INVENTION

The present invention relates to a device measuring flow rate. More specifically the present invention relates to a thermal mass flow meter.

### BACKGROUND OF THE INVENTION

Thermal mass flow meters generally use combinations of heated elements and temperature sensors to measure the difference between static and flowing heat transfer to a fluid and infer its flow with knowledge of the fluid's specific heat and density. The fluid temperature is also measured and compensated for. If the density and specific heat characteristics of the fluid are constant, the meter can provide direct mass flow readout, and does not need any additional pressure temperature compensation over their specified range.

While all thermal flow meters use heat to make their flow measurements, there are two different methods for measuring how much heat is dissipated. Thermal flow meters using constant temperature differential have two temperature sensors—a heated sensor and another sensor that measures the temperature of the gas. Mass flow rate is computed based on the amount of electrical power required to maintain a constant difference in temperature between the two temperature sensors.

Thermal flow meters that are using a second method called a constant current method also have a heated sensor and another one that senses the temperature of the flow stream. The power to the heated sensor is kept constant. Mass flow is measured as a function of the difference between the temperature of the heated sensor and the temperature of the flow stream.

Technological progress has allowed the manufacture of thermal mass flow meters on a microscopic scale as MEMS sensors. These flow devices can be used to measure flow rates in the range of nano liters or micro liters per minute. One advantage of MEMS sensors is their capability to read a wide range of flow rates. However, the MEMS sensors are very expensive and there is a need for a more affordable system capable of accurately measuring flow rates.

Thermal mass flow meter technology is commonly used for compressed air, nitrogen, helium, oxygen and natural gas. In fact, most gases can be measured as long as they are fairly clean and non-corrosive. For more aggressive gases, the meter may be made of specialty alloys (e.g. Hastelloy®). Pre-drying the gas also helps to minimize corrosion.

Accordingly, there is a need for a method that overcomes the disadvantages of the existing technology. The method as disclosed herein overcomes the deficiencies of known art. The method as disclosed here provides a device capable of providing accurate flow measurement of fluid or gas while being economically affordable and simple to manufacture and use. Therefore, the current invention represents a significant improvement over prior art.

### SUMMARY OF THE INVENTION

It is an object of this invention to provide a device for an economic and accurate way to measure gas or fluid flow rates.

It is a further object of this invention to provide a method for an economic and accurate way to measure gas or fluid flow rates.

Another object of this invention is to provide a gas/fluid flow meter that may be battery operated.

Yet another object of this invention is to provide a gas/fluid flow meter and method to measure flow rate where the heating element and the temperature sensors are inside the pipe where the gas or fluid flows.

A further object of this invention is to provide a gas/fluid flow meter and method to measure the flow rate where the heating element is turned off after every measurement.

Yet another object of this invention is to provide a flow meter and a method to measure the flow rate where any temperature changes of the fluid/gas can be calibrated out with each new measurement.

Still another object of this invention is to provide a flow meter and method to measure flow rate where any effects of tilted sensor board can be eliminated.

In accordance with a preferred embodiment of the present invention there is provided:
A thermal mass flow meter, comprising:
   a housing;
   a power supply;
   an amplifier;
   a microprocessor; and
   a flow display;
      said housing having an inlet and an outlet for a gas or fluid flow, and said housing comprising a laminar flow element locating at the inlet and at least one sensor board inside the housing having a top side and a bottom side;
      said sensor board comprising at least one heating element and at least one upstream temperature sensor and at least one down stream temperature sensor locating downstream the heating element;
      said heating element being connected to the power supply regulated via a power supply enable line by the microprocessor;
      said amplifier being connected to the temperature sensors to amplify temperature readings and sending the amplified readings to the microprocessor connected to the flow display; and
      wherein the microprocessor is programmed to conduct the following steps:
   a) reading a baseline temperature of the temperature sensors, selecting one upstream sensor and one down stream sensor and calculating a baseline temperature difference between the selected temperature sensors,
   b) signaling the power supply to turn on to heat the heating element,
   c) reading a second temperature reading of the selected temperature sensors after the heating element has been on for a period of time and calculating a second temperature difference between the selected temperature sensors,
   d) calculating a flow rate based on subtraction of the base line temperature difference from second temperature difference,
   e) Signaling the power supply to turn off, and repeating steps a) through d).

Preferred embodiments of this invention are illustrated in the accompanying drawings and will be described in more detail herein below.

### BRIEF DESCRIPTION OF THE DRAWINGS

FIG. 1 is a schematic drawing of the invention according to this disclosure.

FIG. 2 shows a vertical cross section of a sensor board.

FIG. 3 shows programming steps of the microprocessor to determine the flow rate.

### DETAILED DESCRIPTION OF THE INVENTION

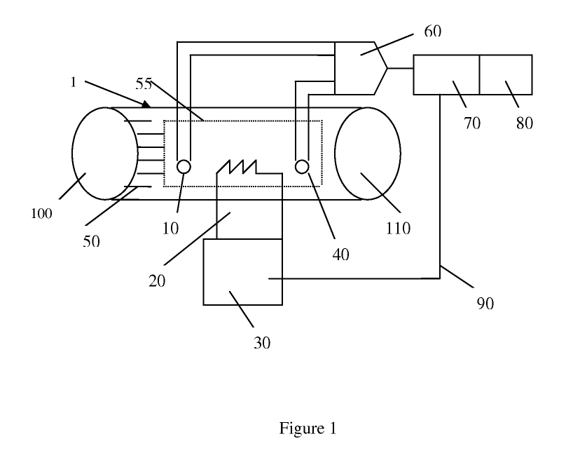

The preferred embodiments of the present invention will now be described with reference to FIGS. 1, 2 and 3 of the drawings.

FIG. 1 is a schematic drawing of the preferred embodiment of the invention. FIG. 1 shows a housing 1, a first temperature sensor (upstream sensor) 10, a heating element 20, a power supply 30, a second temperature sensor (downstream sensor) 40, a laminar flow element 50, a sensor board 55, an amplifier 60, microprocessor 70, flow display 80, power supply enable line 90, pipe inlet 100 and pipe outlet 110.

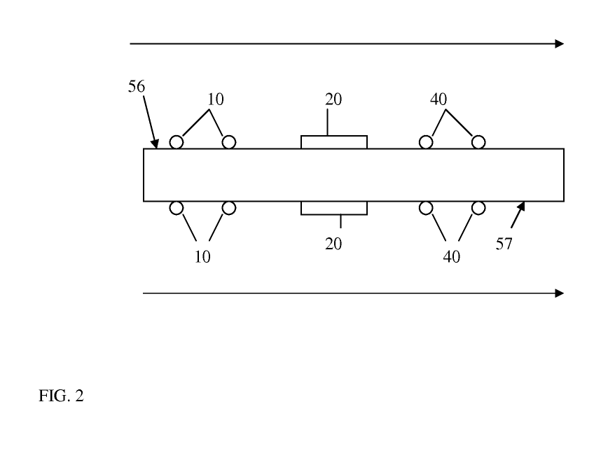

FIG. 2 shows a vertical cross section of a sensor board 55. The direction of the flow is shown in the figure. The sensor board has a top side 56 and a bottom side 57. FIG. 2 shows a heating element 20 on both sides of the board and two temperature sensors 10, 40 on both sides of the heating element.

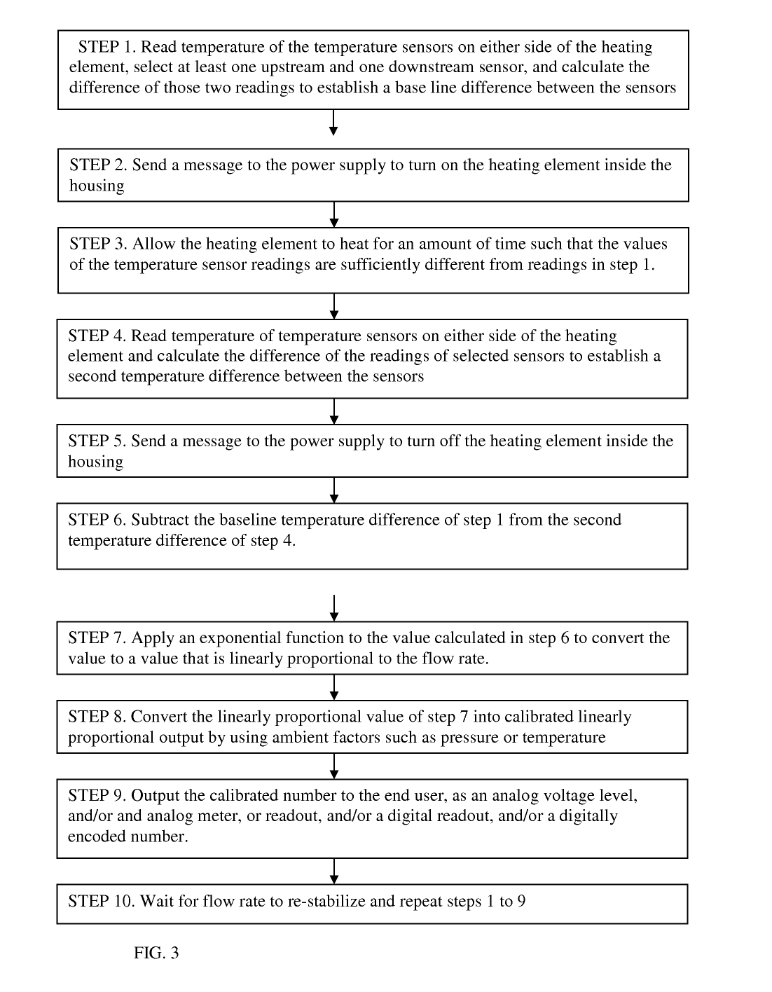

FIG. 3 shows the programming of the microprocessor. In step 1 the microprocessor reads the temperature of the two temperature sensors on either side of the heating element. The microprocessor is programmed to select a pair of sensors consisting of one upstream sensor and one downstream sensor, and calculate the difference between the temperature readings of the two selected sensors to establish a base line temperature difference between the selected sensors.

In step 2 the microprocessor is programmed to send a message to the power supply to turn on the heating element inside the housing.

In step 3 the microprocessor is programmed to allow the heating element to heat for an amount of time such that the values of the temperature sensor readings are sufficiently different from the readings of step 1. The heating element is preferably turned on for 0.1 to 10 seconds, more preferably for 0.5 to 5 seconds and most preferably for one second. This heating period generates temperature increase of approximately 1 to 50° F., more preferably 5 to 20° F. and most preferably approximately 10° F.

In step 4 the microprocessor is programmed to read temperature of the temperature sensors on either side of the heating element and calculate the difference of the temperature readings of the sensors selected in step 1 to establish a second temperature difference between the selected sensors.

In step 5 the microprocessor is programmed to send a message to the power supply to turn off the heating element inside the housing to allow the flow to re-stabilize. Preferably the heating element is turned off about 15 seconds before it can be turned on again for a new measurement.

In step 6 the microprocessor is programmed to subtract the baseline temperature difference of step 1 from the second temperature difference of step 4. This value is a temperature difference due to the imbalance in the thermal energy added by the heating elements. This imbalance is logarithmically proportional to the flow rate.

In step 7 the microprocessor is programmed to apply an exponential function to the value calculated in step 6 to convert the value to a value that is linearly proportional to the flow rate.

In step 8 the microprocessor is programmed to convert the linearly proportional value of step 7 to a calibrated linearly proportional output by using ambient factors such as pressure or temperature. Alternatively the conversion may be done manually by using a look-up table.

In step 9 the microprocessor is programmed to output the calibrated number to the end user, as an analog voltage level, and/or and analog meter, or readout, and/or a digital readout, and/or a digitally encoded number.

In step 10 the microprocessor is programmed to wait for flow rate to re-stabilize and repeat steps 1 to 9.

According to one preferred embodiment the mircroprocessor may be programmed to select more than one pair of sensors in step 1 and make the calculations for readings of one heating cycle for multiple sensor pairs simultaneously.

According to another preferred embodiment the microprocessor may be programmed to measure temperature of selected sensors after the heating element has been turned off in step 5 and make the calculations of steps 1 to 9. This embodiment would allow to follow movement of a temperature pulse created by turning the heating element on and to calculate gas/fluid velocity when the distance between temperature sensors is known.

Now referring to FIG. 1; the device according to this disclosure comprises a housing 1 that is preferably in a form of a pipe. The pipe has an inlet 100 and an outlet 110 for the gas or fluid to flow through. The housing 1 comprises a laminar flow element 50, and a sensor board 55. The sensor board 55 comprises a heating element 20 and at least one upstream temperature sensor 10, and at least one down stream temperature sensor 40. The temperature sensors are wired to amplifiers 60 that increase the signal level of the sensors when presented to a microprocessor 70. The information generated by the microprocessor 70 is displayed on a flow display 80.

The material of the housing pipe depends on the type of gas or fluid that is measured and conditions where the measurements are to be conducted. According to one preferred embodiment the housing is made of brass, but other alloys may also be used.

According to one preferred embodiment the housing is 2 to 5 inches long and more preferably 3 inches long. According to one preferred embodiment the interior diameter of the housing pipe is ¼ to 1 inches and more preferably ½ inches.

According to one preferred embodiment the housing is attached to a source of gas flow (appliance), for example a gas container, with a ¼″ NPT threaded connection. According to this embodiment the housing would locate after the appliance regulator.

According to another preferred embodiment the housing is attached to a source of gas flow (appliance) with a QCC fitting. According to this embodiment the housing is before the appliance regulator.

The laminar flow element 50 preferably locates near the inlet of the pipe 100 so as to enable laminar flow of the gas or fluid without turbulences that would make the measurements inaccurate. The laminar flow element preferably comprises a multitude of small pipes. According to a preferred embodiment the laminar flow element is a pipe having a diameter of about 0.5 inches and it is made of 50 smaller tubes with a diameter of 0.1 inches bundled together.

The sensor board 55 locates preferably in middle of the housing pipe 1 where the gas or liquid is flowing, not on periphery of the pipe as disclosed for example in U.S. Pat. No. 7,895,888 which is fully disclosed herein by reference. The sensor board may locate close to the inlet or close to the outlet, but preferably it locates in about middle section of the housing pipe 1.

The sensor board 55 comprises at least two temperature sensors 10, 40 and a heating element 20. The sensors are located on both sides of the heating element upstream of the flow (upstream sensor 10) and downstream of the flow (downstream sensor 40). The distance of the sensors from the heating element does not necessarily need to be equal but according to one preferred embodiment the distance is equal. Two sensors is a minimum number of sensors according to this disclosure but a plurality of sensors may as well be used.

According to one preferred embodiment there is more than one temperature sensor on one side of the heating element and the same amount of temperature sensors on the other side of the heating element 20. However, the number of sensors on one side of the heating element does not necessarily need to be the same as on the other side of the heating element. The temperature sensors locate perpendicularly to the direction of the flow. According to a preferred embodiment the housing is a pipe, and the temperature sensors are located perpendicularly to the longitudinal axis of the housing pipe. FIG. 2 illustrates one embodiment with two sensors on each side of the heating element.

According to a preferred embodiment 2-10 sensors are used, according to a more preferable embodiment 4-6 sensors are used. According to a preferred embodiment there are 4 sensors on a board, 2 on both sides of the heating element (i.e. 2 upstream sensors and 2 down stream sensors).

The temperature sensors 10, 40 used in this invention may be analog sensors, such as MCP9700/9700A or MCP9700/9701A manufactured by Microchip Technology Inc., Chandler Ariz.

The heating element 20 used in this invention is preferably a resistor, such as RCL121810R0FKFK by Digi-Key Corp., Thief River Falls, Minn.

The microprocessor 70 used in this invention may be for example PIC 24FJ64GA004-1/PT by Digi-Key Corp., Thief River Falls, Minn.

Now referring to FIG. 2: FIG. 2 shows another preferred embodiment of the sensor board locating inside the housing pipe. According to this embodiment the sensor board 55 has a top side 56 and a bottom side 57 and it is located in center of the gas/fluid flow. According to this embodiment the sensor board 55 has one heating element 20 and at least one upstream temperature sensor 10 and at lest one downstream temperature sensor 40 on its top side 56, and optionally one heating element 20 and at least one upstream sensor 10 and at least one downstream sensor 40 on its bottom side 57. In FIG. 2 there is a heating element and two upstream sensors 10 and two downstream sensors 40 on both sides of the board (56, 57). According to this embodiment the microprocessor takes readings for sensors on both sides of the sensor board and averages the results. This embodiment is preferred in that it would help minimize effects causing flow to favor one side of the board, such as tilting of the board.

According to one preferred embodiment the flow meter has more than one sensor board 55. According to this embodiment each sensor board 55 has a thermal element 20 and at least two thermal sensors 10, 40.

The sensors and the heating element are secured on the sensor board for example by an adhesive. The sensor board may be made of any feasible material, including plastics and metal alloys.

The heating element is connected to a power supply 30 which is turned on and off by power supply enable line 90 operated by the microprocessor 70. The power supply is preferably a battery.

The two or more thermal sensors are connected to an amplifier 60 that amplifies the signal before being presented to the microprocessor 70.

Once the gas or fluid flow is set to run through the housing 1, a baseline reading of the plurality of the temperature sensors 10, 40 is taken before the heating element 20 is powered by the power supply 30. The heating element is enabled by the power supply enable line 90 operated by the microprocessor. The heating element is allowed to heat the gas/fluid for a period of time that is sufficient for the thermal sensors to read changed values, preferably for about one second. A second reading of the temperature sensors is made at this time. Heating element 20 is now turned off, preferably for about 15 seconds to re-stabilize the flow before a new measurement can be done.

The microprocessor is programmed to select two temperature sensors, one on each side of the heating element, i.e. one upstream sensor and one downstream sensor to calculate a difference of the temperatures measured before the heating element was turned on (baseline difference). The microprocessor calculates difference between the temperatures measured by the same sensors at the second reading. The microprocessor is programmed to turn the heating off after the measurement. The microprocessor is programmed to subtract the baseline difference reading from a difference of temperatures measured at the second reading. This provides the micro-processor 70 with a temperature difference due to the imbalance in thermal energy added by the heating element 20. This imbalance is logarithmically proportional to the flow rate. The micro-processor 70 converts the final number from the temperature sensor reading into calibrated flow rate using pressure and temperature as factors. The calibrated number will be displayed on a flow display. Once the measurement is done, the micro-processor will wait until the temperature differences in the housing pipe are destabilized (preferably about 15 seconds), a new baseline reading is taken from each thermal sensor, the heating element is turned on for a short period of time and a second reading is made. The difference between the baseline readings in selected two thermal sensors is distracted from the difference of between the second reading and the flow rate is calculated based on the imbalance.

According to one preferred embodiment the microprocessor is programmed to calculate temperature differences between more than one sensor pair at a time.

The advantages of the device and method according to this invention include the following:

The device is economical to make as it does not need expensive MEMS technology. The device is battery operated. It is an essential part of the invention that the heating element is turned on and off. This gives an extra advantage of looking for on/off modulation downstream of the heating element and to separate velocity of the fluid from the pressure of the fluid. The time of an arrival of a temperature pulse can be followed at different temperature sensors (i.e. programming the microprocessor to use more than one sensor pair at a time), and knowing the distance between the sensors a velocity can be determined for the fluid/gas. Furthermore, using the on/off modulation of the heater, some conclusion can be drawn from the shape of the temperature waveforms seen at the sensors. The pressure around the elements for example can be determined, because faster responding waveforms indicate a denser fluid which is conducting the heat away from the heater faster. Slower waveform indicates a lower pressure environment.

Another advantage of the device according to this disclosure is that due to the on/off modulation of the heater, any changing temperatures of the fluid/gas can be calibrated out with each new measurement.

Yet another advantage of this device is that the heating element and the temperature sensors are on a sensor board that is inside the housing pipe where the fluid/gas flows. This allows providing a sensor board that comprises heating element and temperature sensors on both sides of the board. When the flow rate is measured from both sides of the board any inaccuracies that would be due to tilt of the sensor board are eliminated.

A further advantage of the current invention is that it can be used for measuring flow from two directions.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A thermal mass flow meter, comprising:
a housing;
a power supply;
an amplifier;
a microprocessor; and
a flow display;
said housing having an inlet and an outlet for a gas or fluid flow, and said housing comprising a laminar flow element locating at the inlet and at least one sensor board inside the housing having a top side and a bottom side;
said sensor board comprising at least one heating element and at least one upstream temperature sensor and at least one down stream temperature sensor locating downstream the heating element;
said heating element being connected to the power supply regulated via a power supply enable line by the microprocessor;
said amplifier being connected to the temperature sensors to amplify temperature readings and sending the amplified readings to the microprocessor connected to the flow display; and
wherein the microprocessor is programmed to conduct the following steps:
f) reading a baseline temperature of the temperature sensors, selecting one upstream sensor and one down stream sensor and calculating a baseline temperature difference between the selected temperature sensors,
g) signaling the power supply to turn on to heat the heating element,
h) reading a second temperature reading of the selected temperature sensors after the heating element has been on for a period of time and calculating a second temperature difference between the selected temperature sensors,
i) calculating a flow rate based on subtraction of base line difference from second temperature difference,
j) Signaling the power supply to turn off, and repeating steps a) through d).

2. The flow meter according to claim 1, wherein the housing is a pipe.

3. The flow meter according to claim 1, wherein the sensor board has one heating element on either the top side or the bottom side.

4. The flow meter according to claim 3, wherein the sensor board has at least two upstream sensors and at least two downstream sensors.

5. The flow meter according to claim 1, wherein the sensor board has one heating element on the top side and one heating element on the bottom side and at least one upstream temperature sensor and at least one downstream temperature sensor on the bottom side and on the top side of the board.

6. The flow meter according to claim 5, wherein the microprocessor calculates the flow rate in step d) of claim 1 separately for readings of each side of the sensor board and averages the results.

7. The flow meter according to claim 5, wherein the sensor board has multiple upstream temperature sensors and multiple downstream temperature sensors on both sides of the board.

8. The flow meter according to claim 1, wherein the flow meter has multiple sensor boards.

9. The flow meter according to claim 1, wherein the housing is made of brass.

10. The flow meter according to claim 1, wherein the laminar flow element comprises a multitude of tubes.

11. The flow meter according to claim 1, wherein the power supply is a battery.

12. A thermal mass flow meter, comprising:
a housing;
a power supply;
an amplifier;
a microprocessor; and
a flow display;
said housing being a pipe and having an inlet and an outlet for a gas or fluid flow, said housing comprising a laminar flow element and a sensor board inside the housing,
said laminar flow element locating at the inlet and comprising a multitude of tubes,
said sensor board having top side and a bottom side and comprising a heating element and at least one upstream temperature sensor and at least one down stream sensor;
said heating element being connected to the power supply regulated via a power supply enable line by the microprocessor;
said amplifier being connected to the temperature sensors to amplify temperature readings and sending the amplified readings to the microprocessor connected to the flow display; and
wherein the microprocessor is programmed to conduct the following steps:
a) reading a baseline temperature of the temperature sensors, selecting one upstream sensor and one downstream sensor, and calculating a baseline temperature difference between the selected sensors,
b) signaling the power supply to turn on to heat the heating element,
c) reading a second temperature reading of the selected temperature sensors after the heating element has been on for a period of time and calculating a second temperature difference between the selected temperature sensors,
d) calculating a flow rate based on subtraction of base line difference from second temperature difference,
e) Signaling the power supply to turn off, and repeating steps a) through d).

13. The flow meter of claim 12, wherein the power supply is a battery.

14. The flow meter of claim 13, wherein in step g) the battery is turned on for approximately one second.

15. The flow meter of claim 14, wherein in step j) the battery is turned off for approximately 15 seconds before repeating steps a) through d).

16. A thermal mass flow meter, comprising:
a housing;
a power supply;
an amplifier;
a microprocessor; and
a flow display;
said housing being a pipe and having an inlet and an outlet for a gas or fluid flow, said housing comprising a laminar flow element and a sensor board inside the housing,
said laminar flow element locating at the inlet and comprising a multitude of tubes,
said sensor board having top side and a bottom side and comprising a first heating element and at least one upstream temperature sensor and at least one downstream temperature sensor on the top side and a second heating element and at least one upstream temperature sensor and at least one downstream temperature sensor on the bottom side;
said first and second heating element being connected to the power supply regulated via a power supply enable line by the microprocessor;
said amplifier being connected to the temperature sensors to amplify temperature readings and sending the amplified readings to the microprocessor connected to the flow display; and
wherein the microprocessor is programmed to conduct the following steps:
a) reading a baseline temperature of the temperature sensors,
b) selecting one upstream and one downstream sensor on the top side and calculating a baseline temperature difference between the selected sensors,
c) selecting one upstream and one downstream sensor on the bottom side and calculating a baseline temperature difference between the selected sensors,
d) signaling the power supply to turn on to heat the heating element,
e) reading a second temperature reading of the selected temperature sensors on the top side and on the bottom side after the heating element has been on for a period of time and calculating a second temperature difference between the selected sensors on the top side and on the bottom side,
f) calculating a flow rate above the sensor board based on subtraction of base line difference from second temperature difference of the top side readings
g) calculating a flow rate below the sensor board based on subtraction of base line difference from second temperature difference of the bottom side readings
h) averaging the rates of steps f) and g) and
i) Signaling the power supply to turn off, and repeating steps a) through g).
